(19) United States
(12) Patent Application Publication
(10) Pub. No.: US 2022/0269299 A1
(43) Pub. Date: Aug. 25, 2022

(54) Pedal assembly for pedal braking control of a motor vehicle

(71) Applicant: AKWEL, Champfromier (FR)

(72) Inventors: Juan CARCELEN, Perriers-sur-Andelles (FR); Christophe GREGOIRE, Bosc-Berenger (FR); Christophe DEVARENNE, Hautbos (FR); José Oscar VAZQUEZ CARBALLO, Vigo (ES)

(73) Assignee: AKWEL, Champfromier (FR)

(21) Appl. No.: 17/673,194

(22) Filed: Feb. 16, 2022

(30) Foreign Application Priority Data
Feb. 24, 2021 (FR) 2101775

(51) Int. Cl. G05G 1/40; B60T 7/06

(52) U.S. Cl. CPC G05G 1/40; B60T 7/06

(57) ABSTRACT

The pedal assembly includes a support, a pedal mounted pivoting around a pivot axle of the support and an articulated connection, the connection being configured to connect the pedal to a transverse return bar connected to a control device, provided to be mounted on the other side of the vehicle, such that the application of a functional torque for driving the pedal around the axle from a raised configuration to a depressed configuration drives the rotation of the bar. The pedal assembly includes a member for adjusting a functional clearance of the pedal, the member being configured to exert a resistive torque on the pivot axle of the pedal in a direction opposite to the direction of the functional torque, which tends to disappear during the depression of the pedal.

The present invention relates to a pedal assembly for pedal control of a steering function of a motor vehicle, in particular a braking function, as well as a pedal control comprising such a pedal assembly.

A braking control of a motor vehicle generally includes a brake pedal acting on a master cylinder, to transmit a hydraulic pressure to wheel brakes. The brake pedal is generally fastened in the passenger compartment of the vehicle on a metal plate called firewall, separating the passenger compartment from the compartment located at the front of the vehicle that receives the powertrain.

Generally, in the front compartment, there is a depression brake booster successively fastened to this firewall, which generates a complementary assistance force, and the master cylinder positioned in the axis of the brake booster, and fastened to this booster.

Most vehicles include a cockpit located on the left side of the passenger compartment, for driving on the right side of the road. The brake pedal of this cockpit acts directly via a control rod, on the master cylinder disposed in front of this pedal.

However, in some countries such as the United Kingdom, Japan or also Australia, people drive on the left side of the road, and the cockpit of the vehicle is located on the right side of the passenger compartment.

Automobile manufacturers generally originally design their vehicle for a left-hand drive, and provide an adaptation to dispose the cockpit on the right while keeping the brake booster and the master cylinder on the left side. This universal design makes it possible to produce vehicles according to the two layouts, without moving the braking components that are in the front compartment.

Such an adaptation is known, particularly from the document FR-A1-2790116 that provides a transverse return bar fastened to the firewall and rotationally guided according to its axis, which is controlled by the brake pedal located on the right-hand side of the passenger compartment, to drive on the left-hand side a control lever of the braking system.

Under the effect of the rotation of the return bar, the control lever that is facing the master cylinder, then acts directly on this master cylinder by means of a control lever.

Such an arrangement makes it possible to simplify the adaptation of the motor vehicle for driving on the left-hand side of the road when the vehicle was initially provided for driving on the right-hand side of the road.

However, the transfer of the pedal assembly in relation to the braking control device by means of a transverse return bar causes undesirable vibrations at the pedal particularly during a phase for driving the vehicle on uneven ground, for example cobblestones. Such vibrations are detrimental to the overall perception of the perceived quality of the motor vehicle by the user.

One aim of the present invention is to remedy this drawback.

To this end, the object of the invention is particularly a pedal assembly for pedal control of a steering function of a motor vehicle, in particular a braking function, comprising a support provided to be mounted laterally on one side of the motor vehicle, a pedal mounted pivoting around a pivot axle of the support and an articulated connection, said connection being configured to connect the pedal to a transverse return bar of said control connected to a device for controlling the steering function, provided to be mounted on the other side of the vehicle, such that the application of a functional torque for driving said pedal around said axle from a raised inactive configuration to a depressed active configuration drives the rotation of the bar by means of the articulated connection causing the actuation of said device, characterised in that the pedal assembly comprises a member for adjusting a functional clearance of the pedal, said member being configured to exert a resistive torque on said pivot axle of the pedal in a direction opposite to the direction of said functional torque, which tends to disappear during the depression of the pedal.

Thanks to the adjustment member, the pedal assembly makes it possible to prevent vibrations at the pivot axle of the pedal during driving phases, particularly on uneven ground. Moreover, in the case of a braking control, as the resistive torque tends to disappear during the braking phase to the benefit of the functional torque ensuring the braking function, it does not in any way disrupt the optimal operation of this steering function.

Within the meaning of the present invention, the expression “disappearance of the resistive torque” will mean that the intensity of the resistive torque becomes minority or even residual, in relation to the intensity of the opposite functional torque making it possible to perform the steering function, for example by progressively reducing or attenuating it, or even cancelling it out during the depression of the pedal.

In another preferred embodiment of the invention, the adjusting member comprises a spring configured to adopt in the raised configuration of the pedal, an operating state wherein the spring exerts a force on the pedal by urging it to pivot around its axle in a direction opposite to its direction of depression and to adopt during the depression of the pedal, a relaxed state wherein the spring tends to release the pedal from the exertion of its force.

In another preferred embodiment of the invention, the member comprises a spring operating in compression, mounted integral with said articulated connection, and configured to exert a compressive force against the pedal in its operating state.

In another preferred embodiment of the invention, the articulated connection supports the spring so as to position at least one upper compression surface of the spring substantially in line and in contact with a lower edge of the pedal in the raised configuration of the pedal and to move it away, for example angularly, from said lower edge during the depression of the pedal.

In another preferred embodiment of the invention, the articulated connection comprises a tie rod connected to a substantially middle portion of the pedal in a first rotational joint and a driving lever configured to be mounted in a rotationally fixed manner on the return bar and connected to the tie rod in a second rotational joint, said compression spring being supported by the tie rod.

In another preferred embodiment of the invention, wherein the tie rod supports the spring so as to position, in the raised configuration, a lower compression surface of the spring substantially in line and in contact with a surface of a top portion of the driving lever, adjacent to the second joint.

In another preferred embodiment of the invention, the lower edge of the pedal comprises a profile delimiting a groove in the middle portion of the pedal, adjacent to the first joint, the tie rod supports the compression spring so as to position a compression surface of the spring opposite a surface of said groove, in the raised configuration.

In another preferred embodiment of the invention, the tie rod comprises a body defining a central portion and two joint end portions, said central portion being provided with a back or front projection delimiting a housing for receiving the compression spring configured to position a compression surface of the spring against a lower edge of the pedal, in the raised configuration of the pedal.

In another preferred embodiment of the invention, the body of the tie rod comprises two tongues extending in the direction of their length in a longitudinal direction of the tie rod opposite one another and being connected in the central portion of the tie rod via the back or front projection.

In another preferred embodiment of the invention, the tongues of the tie rod locally converge towards one another to define a tightening area shaped to hold tightly and retain a securing lug formed in the spring.

In another preferred embodiment of the invention, the tie rod is obtained by bending in two a single metal part, said part comprising two oblong lateral portions configured to form the tongues and an intermediate portion for mutual transverse connection of the two oblong portions configured to form the projection delimiting the housing of the spring, the part being bent so as to bring the oblong portions opposite one another by curving the intermediate portion on itself to delimit a wall of the housing.

In another preferred embodiment of the invention, the tie rod and the compression spring consist of a single part obtained by two-material injection moulding of a first plastic material by filling a free cavity of a mould delimiting the body of the tie rod provided with a hollow bore and by injection moulding of a second plastic material by filling at least the hollow bore of the tie rod to form the compression spring.

In another preferred embodiment of the invention, the bore forms a channel passing through the projection in a longitudinal direction of the tie rod, said channel opening out on the side of the first joint of the tie rod and on the side of the second joint of the tie rod.

In another preferred embodiment of the invention, the compression spring is formed by a stud made of deformable elastomer material, such as polyurethane.

In another preferred embodiment of the invention, the member comprises a torsion spring of the winding type mounted around the pivot axle, urging the pedal to pivot around its axle in a direction opposite to an operational direction of depression of said pedal.

In another preferred embodiment of the invention, the pedal comprises a relief configured to bring the spring in a prestressed operating state, in the raised configuration of the pedal, and to release the spring from this prestressed state at the beginning of a depression stroke of the pedal.

In another preferred embodiment of the invention, the relief is formed by a recess formed in an upper edge of the pedal that defines a bearing seat against which comes to apply an end portion of the spring.

In another preferred embodiment, the torsion spring comprises an end portion integral with the pedal and a free end portion that is configured to come to press against the support in the raised position of the pedal so that the spring is in a prestressed state and is configured to be released from its pressing against the support in the depressed position of the pedal so that the spring is in a rest position.

In another preferred embodiment the pedal body comprises an orifice offset in relation to the pivot axle inside of which is inserted the end portion of the spring.

Other specific features and advantages of the invention will become apparent in light of the following description, made with reference to the appended figures, wherein:

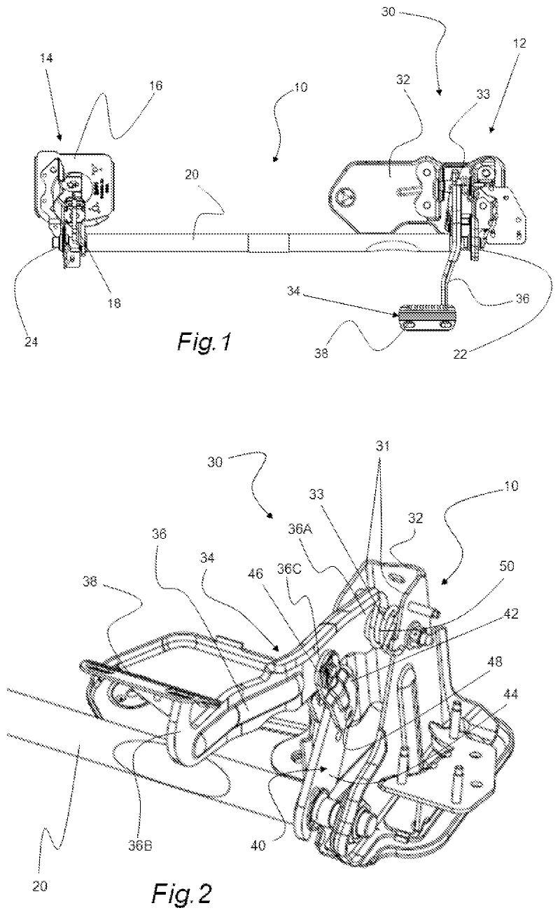

FIG. 1 shows a front and perspective view of a pedal control with a right side, at the feet of the driver and a left side, at the feet of the passenger, comprising a pedal assembly according to a first embodiment of the invention mounted on the right side of the control;

FIG. 2 is a perspective front three-quarter view of the right side of the pedal assembly of FIG. 1;

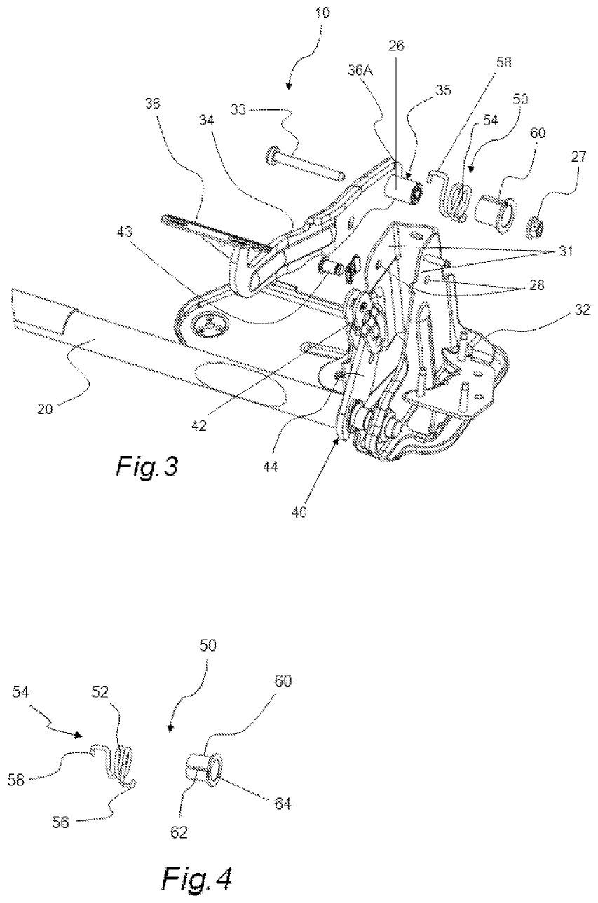

FIG. 3 is an exploded perspective view of the pedal assembly of FIG. 2;

FIG. 4 is a perspective view of a member for adjusting a functional clearance of the pedal assembly of FIG. 1 in a dismantled state;

FIGS. 5A, 5B and 5C illustrate three operating steps of the member of FIG. 4;

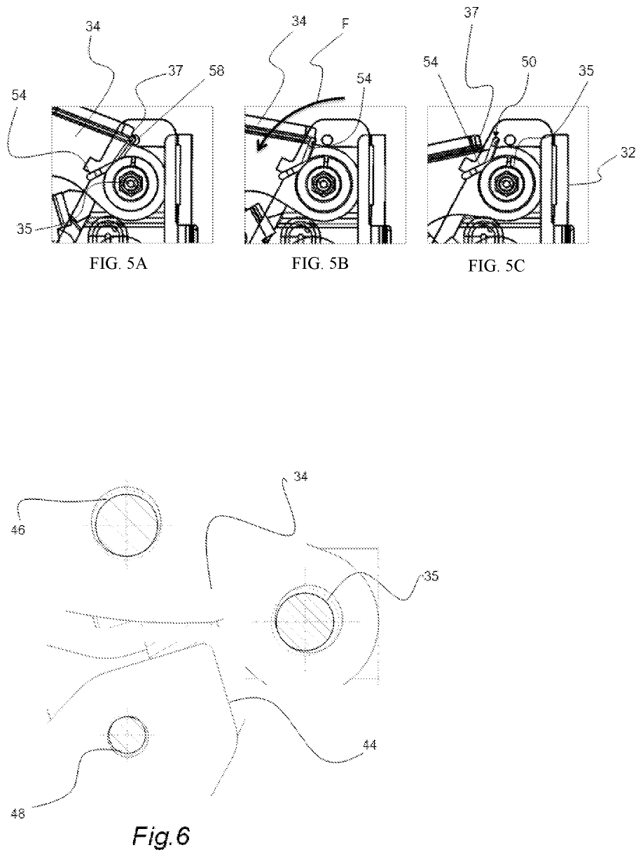

FIG. 6 schematically illustrates a functional clearance of the pedal at its three joints;

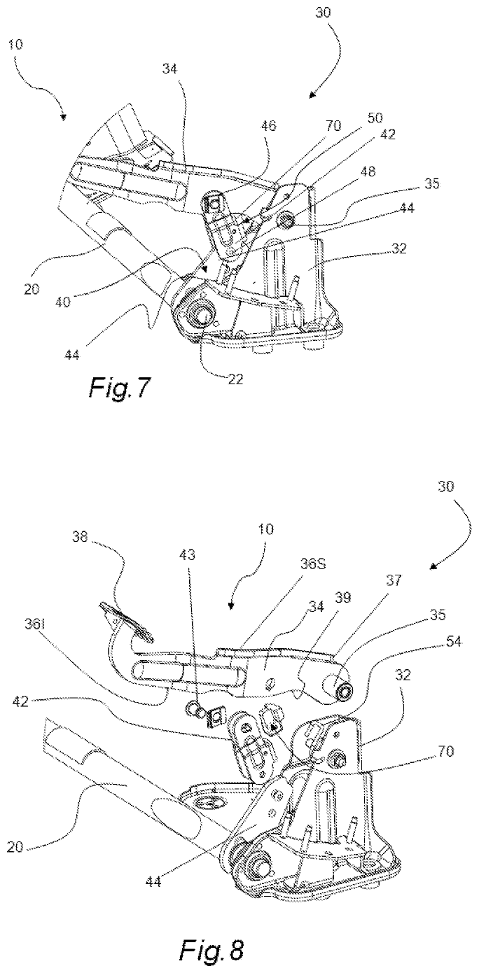

FIG. 7 shows a side perspective view of a pedal control comprising a pedal assembly according to a second embodiment of the invention;

FIG. 8 shows an exploded perspective view of the pedal assembly shown in FIG. 7;

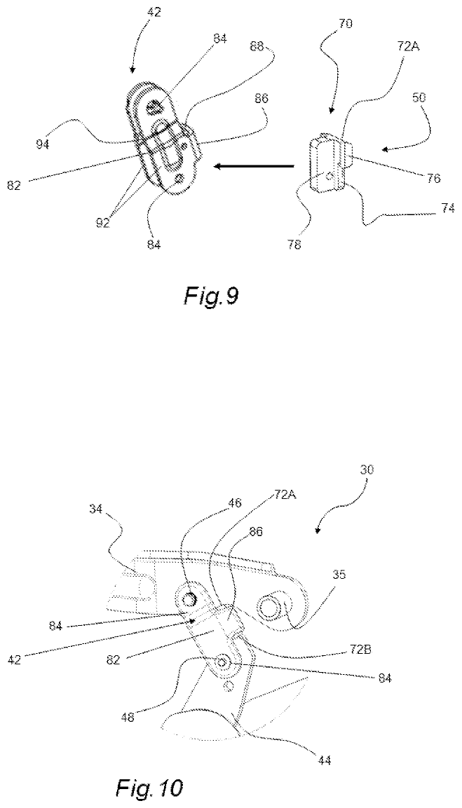

FIG. 9 shows a perspective view of a tie rod and of an adjustment member of the pedal assembly according to the second embodiment of the invention;

FIG. 10 shows a partial perspective view of a pedal and of an articulated connection of the pedal assembly in accordance with a third embodiment of the adjustment member in a raised configuration of the pedal;

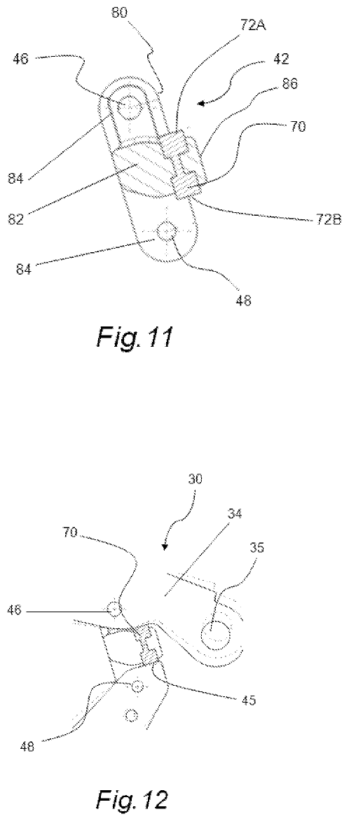

FIG. 11 shows a cutaway and sectional view of the tie rod of the pedal assembly of FIG. 10;

FIG. 12 shows a sectional view of the pedal assembly of FIG. 10 shown in continuous line the pedal assembly in its raised configuration and in discontinuous line the pedal assembly in its depressed configuration;

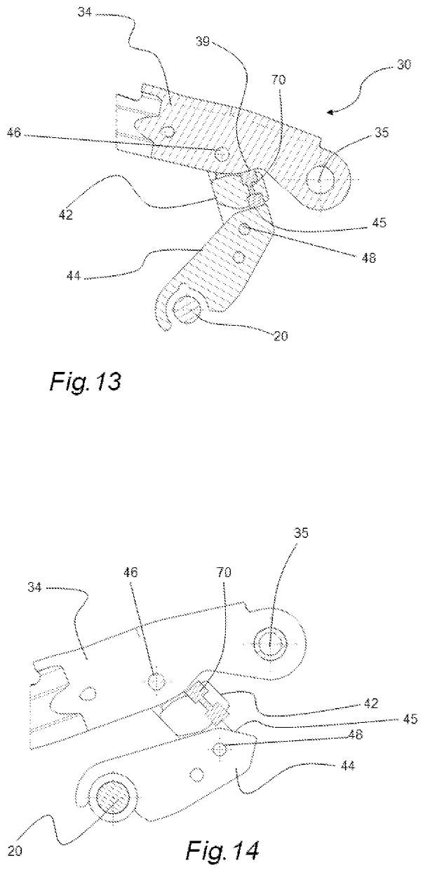

FIG. 13 shows a sectional view of the pedal assembly of FIG. 10 in the raised configuration of the pedal;

FIG. 14 shows a sectional view of the pedal assembly of FIG. 10 in a depressed configuration of the pedal;

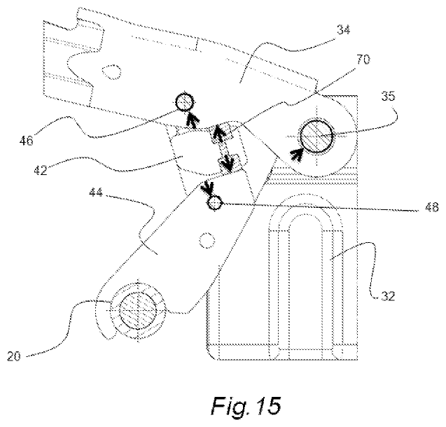

FIG. 15 is a sectional view of the pedal assembly of FIG. 10 schematically illustrating the operating principle of the adjustment member of the invention;

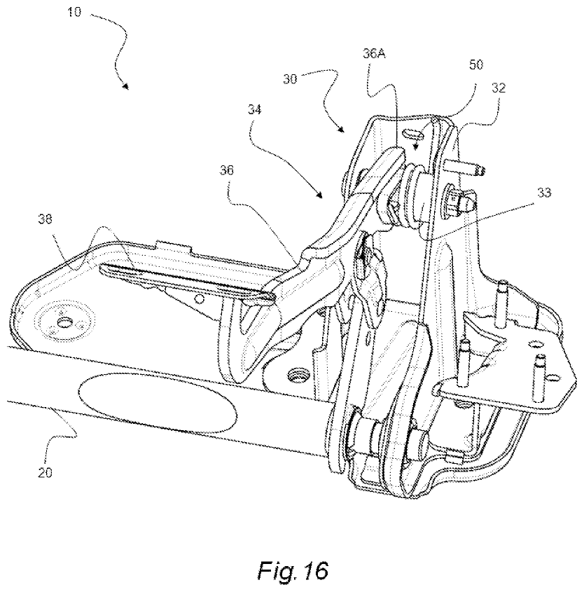

FIG. 16 is a perspective view showing a first alternative embodiment of the control of FIG. 1;

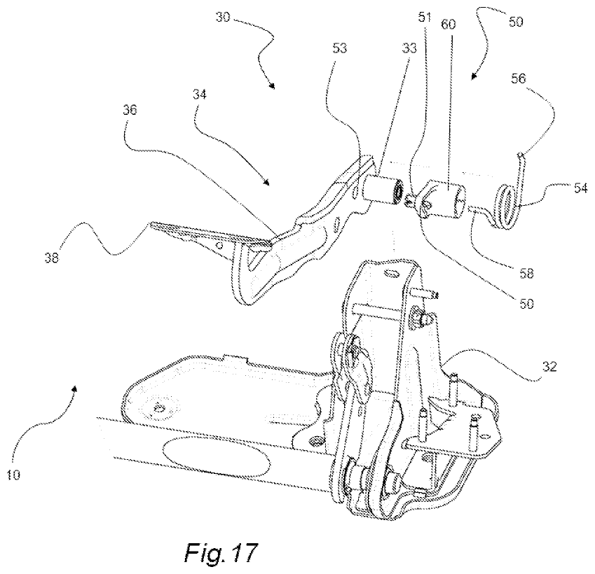

FIG. 17 is an exploded perspective view of the control of FIG. 16;

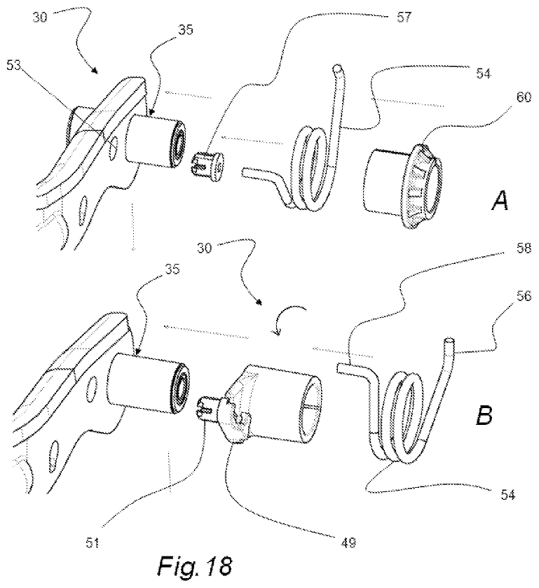

FIG. 18 is a perspective view showing second and third variants of a clearance adjustment member of the control of FIG. 16.

FIGS. 1 to 18 schematically show a pedal control of a motor vehicle comprising a control device and a pedal assembly acting on this control device. In the remainder of the description, this pedal control is designated by the general reference 10 and the pedal assembly bears the general reference 30.

Within the meaning of the present invention, the terms “back”, “front”, “lower”, “upper”, “lateral”, “right”, “left” are defined by considering the layout of the elements such as shown in FIG. 1, that is to say according to a viewpoint of a user of the vehicle located facing the steering control 10 in a position of use of this control 10.

Generally, this pedal control 10 makes it possible to control a steering function of the motor vehicle. In the case of the present description, the steering function performed by the pedal control 10 is a braking function. In the remainder of the description, it will be considered that the control device is a braking device that is not shown in the figures. Of course, it may also be envisaged to apply the invention to another steering function of the motor vehicle, such as a clutching function.

Generally, the pedal assembly 30 is fastened in the passenger compartment of the vehicle on a metal plate called firewall (not shown), separating the passenger compartment from the compartment located at the front that receives the powertrain.

In a manner known per se, the braking device is for example mounted in the front compartment of the motor vehicle and is separated from the pedal assembly 30 by the firewall. It comprises for example a master cylinder that makes it possible to transmit a hydraulic pressure to wheel brakes and a vacuum brake booster, which is provided to generate an additional assistance force and whereon the master cylinder is generally fastened.

More particularly, this pedal control 10 is provided to be adapted to driving the vehicle on the left-hand side of the road, with a right-hand cockpit comprising the pedal assembly 30 while maintaining a left-hand arrangement of the braking device of the vehicle.

Thus, the pedal assembly 30 is transferred on the right side 12 of the vehicle at the feet of a driver whereas the braking device is located on the left side 14 of the vehicle so as to be opposite the feet of the passenger. In general, as illustrated in FIG. 1, on the left side 14, the control 10 comprises a support 16 and a lever 18 acting on the braking device, as will be subsequently described in detail.

In order to make it possible for the pedal assembly 30 located on the right side 12 to act on the braking device located on the left side 14 of the braking control 10, the control 10 also comprises a transverse return bar 20 connected on the right side to the pedal assembly 30 and on the left side 14 to the braking device.

This arrangement advantageously makes it possible to be adapted to both versions (driving on the left-hand side or on the right-hand side of the road) without resorting to moving the components of the braking device in the front compartment depending on the desired version of the motor vehicle.

The pedal assembly 30 also comprises a support 32 provided to be mounted laterally on one side of the motor vehicle, here the right side 12 of this vehicle and a pedal 34 mounted pivoting around a pivot axle 33 of the support 32.

Preferably, as seen in particular in FIG. 2, the pedal 34 comprises an elongated body 36 generally arm shaped comprising an upper portion 36A comprising a main joint 35 around the pivot axle 33, a central or middle portion 36C and a lower portion 36B forming a pad 38 receiving the pressure of the foot of the driver.

In this example, the pivot axle 33 comprises a generally cylindrical shaft extending between two lateral flanges 31 of the support 32 extending parallel with one another and each passed through by an orifice 28. The pedal 34 comprises in the example illustrated, at the main joint 35 of its upper portion 36A a rotational guide bearing 26 inside of which the shaft 33 is engaged.

Furthermore, the pedal assembly 30 comprises an articulated connection 40 configured to connect the pedal 34 to the return bar 20 such that the application of a functional torque for driving the pedal 34 around said pivot axle 33 from an inactive raised configuration to an active depressed configuration drives the rotation of the bar 20 and the actuation of the braking device.

In this example, the connection 40 comprises a tie rod 42 connected to a central portion 36C of the pedal 34 in a first rotational joint 46 and a driving lever 44 rotationally fixed to the bar 20 and connected to the tie rod 42 in a second rotational joint 48. The tie rod 42 is for example mounted on the central or middle portion 36C of the pedal 34, at its first joint 46, by removable fastening means 43 (screws, nuts, pins, etc.) which will not be described in more detail below (shown in FIG. 3).

The operation of the articulated connection 40 is described in detail below. The tie rod 42 transmits the pressure applied on the pad 38 of the pedal 34, by means of two so-called “secondary” joints 46 and 48 (as opposed to the so-called “main” joint 35), to the driving lever 44, rotationally fixed to the return bar 20. The bar 20 receives the torque of the brake pedal 34 via the driving lever 44 of the articulated connection of the pedal assembly 30 located at its right end 22, in order to transmit it for example to a driven lever 18 (shown in FIG. 1) that is at its left end 24.

The driven lever 18 thus transmits the torque received from the return bar 20 to the braking device, by passing through the left support 16 and the firewall separating the passenger compartment from the front compartment, in order to apply it to the braking device comprising for example the brake master cylinder and that is on the side of the firewall comprising the front compartment of the motor vehicle.

These three rotational joints formed by the main joint 35 of the pedal 34 on the support 32 and the two secondary joints 46 and 48 of the articulated connection 40 may create a functional clearance of the pedal 34 as schematically illustrated in FIG. 6.

In this FIG. 6, it can be seen particularly that each main 35 or secondary joint 46 or 48 introduces a functional clearance in the kinematic chain of articulation of the pedal 34 of the pedal assembly 30. This functional clearance may result from an axial or radial clearance of the joint elements of the pedal 34. This functional clearance is particular the cause of undesirable vibrations during phases of driving the motor vehicle in particular on uneven ground, such as cobblestones.

In order to remedy this drawback, in accordance with the first and second embodiments of the invention, the pedal assembly 30 also comprises a member 50 for adjusting the functional clearance of the pedal 34.

More particularly, this member 50 is configured to exert a resistive torque on the pivot axle 33 of the pedal 34 in a direction opposite to the direction of the functional torque. In particular, this resistive torque tends to disappear during the depression of the pedal 34. The expression “disappearance of the resistive torque” will mean that the intensity of the resistive torque becomes minority or even residual, in relation to the intensity of the opposite functional torque making it possible to perform the braking function, for example by progressively reducing or attenuating it, or even cancelling it out during the depression of the pedal 34.

Preferably, the member 50 comprises a spring configured to adopt in the raised configuration of the pedal 34, an operating state wherein the spring exerts a force on the pedal 34 by urging it to pivot around its axle 33 in a direction opposite to its direction of depression and to adopt during the depression of the pedal 34, a release state wherein the spring tends to release the pedal 34 from the exertion of its force.

In the first embodiment illustrated in FIGS. 1 to 5, the member 50 comprises a torsion spring 54 mounted around said pivot axle 33 and provided with means for fastening to the support 32 and to the pedal 34 making it possible to exert a torsional resistive torque on the pedal 34. In this way, the torsion spring 54 urges the pedal 34 to pivot around its axle 33 in a direction opposite to an operational direction of depression of said pedal 34.

For example, the helical torsion spring 54 is formed by a metal wire according to a winding shape mounted around said pivot axle 33 having a first end portion 58 acting on the pedal 34 and a second end portion 56 integral with the support 32.

Furthermore, preferably, the pedal 34 comprises a relief 37 configured to position the torsion spring 54 in a prestressed operating state, in the raised configuration of the pedal 34, and to release the spring 54 from this prestressed state during the depression of the pedal 34.

Preferably, the end portion 58 of the spring 54 is provided with a straight section coming to exert a torsional stress on the pedal 34 against the relief 37. Preferably, the pedal 34 has an upper edge 36S comprising a recess forming the relief 37 and delimiting the bearing seat against which comes to apply the end portion 58 of the spring 54. As a variant, the relief may include an orifice passing through the body of the pedal 34 inside of which is provided to be inserted an end portion 58 of the torsion spring 54 or any other form of relief making it possible for the torsion spring 54 to exert a force on the arm 36 of the pedal 34 to bring it to pivot in a direction opposite to the operational direction of depression.

As illustrated in FIGS. 3 and 4, in this first embodiment, preferably, the member 50 also comprises a bushing 60, being provided to be mounted around the shaft 35 by elastic deformation of the bushing 60 and to be inserted between the shaft 35 and the spring 54 mounted around the bushing 60. This bushing 60 comprises for example a generally cylindrical body having a tubular skirt 62 surmounted with a collar 64 and being split in its longitudinal direction. The purpose of this bushing 60 is to limit undesirable noises generated during the deformation of the torsional spring 54.

Three alternative embodiments of this first embodiment of the invention illustrated in

FIGS. 16 to 18 will now be described. In these variants, contrary to the preceding, the helical torsion spring 54 is formed by a metal wire according to a winding shape mounted around said pivot axle 33 having a first end portion 58 integral with the pedal 34 and a second end portion 56 configured to come to press against the support 32 in a raised position of said pedal 34 and to clear the support 32 in the depressed position of the pedal 34. Preferably, the pedal body 36 comprises an orifice 53 offset in relation to the pivot axle 33 inside of which is inserted the end portion 58 of the spring 54.

In a first alternative embodiment illustrated in FIGS. 16 and 17 of the first embodiment, the bushing 60 comprises a generally cylindrical body configured to fit around the pivot axle 33 and is provided with a pierced and offset pawl 51 of axial extension. The pawl 51 extends in the example illustrated from an end face of the bushing 60. For example, the end face does not have a perfectly circular transverse section but is slightly elongated and in “droplet” shape, that is to say having one rounded side and on the opposite side, a slightly tapered tip. The pawl 51 extends axially protruding from this tip.

This pawl 51 is configured in this example to slot inside the orifice 53 provided on the body 36 of the pedal 34, close to the pivot axle 33 and to retain the end portion 58 of the spring 54. The other end portion 56 of the spring 54 is configured to extend freely. The central winding portion of the spring 54 is configured to come to wind around the body of the bushing 60.

During operation, the spring 54 is mounted beforehand on the bushing 60 that is subsequently intended to be fitted on the pivot axle 33. The mounting of the spring 54 on the bushing 60 consists in engaging the central portion around the body of the bushing 60 and in engaging the end portion 58 inside the pawl 51. During the mounting of the bushing 60 on the support 32, the pawl 51 is engaged inside the orifice 53.

In the raised position of the pedal 36, the spring 54 is in a prestressed state: the free end portion 56 of the spring 54 is pressed against the support 32 whereas the end portion 58 of the spring 54 is engaged in the orifice 53 of the pedal body. The angle formed by the two end portions 56 and 58 tightens which comes to exert a torsional stress on the spring 54. In the depressed position of the pedal 36, the spring 54 is in a released state: the end portion 56 of the spring 54 is clear of its bearing against the support 32 because the spring 54 is driven by the movement of the pedal 36 and the angle formed by the two end portions 56 and 58 opens.

In a second alternative embodiment “A” of the first embodiment illustrated in FIG. 18, the member 50 differs from that of the first variant in that the end face of the bushing 60 has a generally rounded main transverse section and the axial pawl 51 is secured to the body of the bushing 60 by a transverse connection arm 49. This connection arm 49 extends for example in a direction tangential to the end face of the bushing 60.

In a third alternative embodiment “B” of the first embodiment illustrated in FIG. 18, the member 50 comprises an eyelet 57, separated from the bushing 60, which comprises a tubular body provided with an elastically deformable skirt so that the eyelet 57 is inserted by deformation inside the orifice 53 of the body 36 of the pedal. The end portion 58 of the spring 54 is thus provided to be inserted inside the eyelet 57.

In these three variants, the free end portion 56 is configured to come to press against the support 32 in the raised position of the pedal 34 so that the spring 54 is in a prestressed state and is configured to be released from its pressing against the support 32 in the depressed position of the pedal 34 so that the spring 54 is in a rest position.

The main operating aspects of the pedal assembly will now be described according to this first embodiment with reference particularly to FIG. 5.

Initially, in the box 5A of FIG. 5, the pedal assembly 30 is in a raised inactive configuration of the pedal 34. In this configuration, the pedal 34 is raised and the torsion spring 54 is secured in a prestressed operating state against the recess relief 37 of the upper edge 36S of the pedal 34. In this operating state of the spring 54, the torsion spring 54 exerts on the pivot axle 33 a resistive torque tending to oppose untimely movements of vibrations of the pedal 34 around its axle 33.

When the driver exerts a pressure on the pad 38 of the braking pedal 34 in a direction of functional pivoting shown schematically by the arrow F illustrated in the box 5B, the relief 37 moves with the pedal 34 by making it possible for the torsion spring 54 to begin a relaxation stroke from its initial prestressed state (as illustrated in box 5A) up to a final relaxed state. This final relaxed state is reached preferably at the beginning of the depression stroke of the pedal 34 so as not to hinder the pivoting of the pedal 34 in the operational direction of braking of the vehicle. It may be considered that the beginning of the depression stroke of the pedal 34 corresponds for example to at most the first half of the total stroke of the pedal 34, for example less than the first third of the total stroke of the pedal 34.

During the pivoting of the pedal 34 in the operational direction up to a depressed active configuration, the recess relief 37 moves away from the end 58 of said spring 54 so that the torsion spring 54 initiates its relaxation stroke releasing the pedal 34 from exerting its torsional stress. Preferably, in order to limit the action of the resistive torque during the depression of the pedal 34, the final relaxed state of the spring 54 is reached at the beginning of the depression stroke of the pedal 34 as already described above.

As soon as the braking action is finished, the pedal 34 reverts to its raised configuration by placing the spring 54 back in its prestressed configuration. FIGS. 7 to 9 shows a second embodiment of a pedal assembly 30 according to the invention. In this second embodiment, the elements similar to the first embodiment bear identical references. It will be noted that in FIGS. 7 to 9, the torsion spring 54 of the first embodiment is shown but in this second embodiment, this torsion spring 54 is optional and may be eliminated without being detrimental to the operation of the pedal assembly 34.

In the second embodiment illustrated by FIGS. 7 to 9, the member 50 comprises a spring operating in compression 70, mounted integral with said articulated connection 40, and configured to exert a thrust force against the pedal 34 in its compressed operating state. It is reminded that although, in FIGS. 7 to 9, it can be seen that the member 50 comprises the torsion spring 54 and the compression spring 70, in this second embodiment, the torsion spring 54 is optional.

Preferably, the compression spring 70 is arranged on the articulated connection 40 such that the spring 70 has a compression surface 72A of the spring 70 substantially in line and in contact with a lower edge 361 of the pedal 34 in the raised configuration of the pedal 34. Moreover, during the depression of the pedal 34, the arrangement of the spring 70 on the connection 40 is provided to make it possible for the spring 70 to move away, for example angularly, from said lower edge 361 during the depression of the pedal 34 in order to release the pedal 34 from the exertion of the force of the spring 70.

Preferably, the compression spring 70 is supported by the tie rod 42. In this example, the tie rod 42 comprises an elongated body 80 defining in a longitudinal direction of the tie rod 42 a central portion 82 and two joint end portions 84.

In the example illustrated, each of the end portions 84 is in the form of a fork defining two parallel pierced flanges between which comes to insert the body of the pedal 34 or the driving lever 44 to respectively form the first secondary joint 46 and the second secondary joint 48.

Furthermore, preferably, said central portion 82 is provided with a back projection 86 delimiting a housing 88 for receiving the spring 70. This housing 88 is preferably configured to position the compression surface 72A of the spring 70 against the lower edge 361 of the pedal 34, in the raised configuration of the pedal 34.

In a variant not illustrated of the invention, the projection 86 may be disposed frontally to the tie rod 42, such a configuration requiring a few adaptations that may be easily deduced from the detailed description of the back configuration of the projection 86 and therefore will subsequently not be described in more detail.

As illustrated in FIG. 9, the body of the tie rod 42 comprises two tongues 92 extending in the direction of their length in a longitudinal direction of the tie rod 42 opposite one another and being connected in the central portion 82 of the tie rod 42 via the back projection 86.

Preferably, the tie rod 42 is made of a metal material from a single metal part, for example by bending this metal part. For example, the part (not shown in its unbent state) is delimited by two oblong lateral portions configured to form the tongues 92 and an intermediate portion for mutual transverse connection of the two oblong portions configured to form the projection 86 delimiting the housing 88. In order to form the tie rod 42, the part is then bent in two in order to bring the oblong portions opposite one another by curving the intermediate portion so as to delimit a peripheral wall 89 of the housing 88.

Preferably, as illustrated in FIG. 9, the spring 70 has a generally stud-shaped body made of a deformable elastomer material. In the example, the body comprises a bottom portion 74 shaped to be engaged inside the receiver housing 88 and a top portion 76, for example rounded, provided with the compression surface 72A and surmounting the bottom portion 74 by forming at least locally one extra thickness in relation to the bottom portion 74. In the example described, this extra thickness comes to press against an upper edge of the wall 89 of the receiver housing 88. As illustrated in FIG. 9, the top portion 76 of the stud forms a shoulder with the bottom portion 74 coming to press against the upper edge of the housing 88.

Furthermore, preferably, the tie rod 42 as a result of the bending in two of the part is deformed so as to locally converge the two tongues 92 towards one another to locally define a tightening area 94 shaped to hold tightly and retain a securing lug 78 arranged in the spring 70.

For example, the body of the spring 70 comprises a protruding excrescence 78, here generally tooth-shaped, configured to be engaged in the tightening area 94 of the two tongues 92 and that then forms the securing lug.

For example, the compression spring 70 is made of an elastomer material, for example a polyurethane elastomer known under the trade name ELADIP®.

In order to install the stud 70 inside its housing 86, the stud 70 is tilted in relation to the tie rod 42 so as to position and to engage the bottom portion 74 in the housing 86 then, the stud 70 is tilted towards the front in the direction of the tie rod 42 so as to engage the securing lug 78 between the two tongues 92 in the tightening area 94. Thanks to this arrangement of the tightened area 94, the tie rod 42 exerts on the stud 70 a force that opposes its removal to guarantee that the stud 70 cannot, through stress, be ejected out of its housing 86.

Furthermore, preferably, the inner edge 361 of the pedal 34 comprises a profile delimiting a groove 39 in the middle portion 36C of the pedal 34, adjacent to the first joint 46. The compression spring 70 is oriented on the tie rod 42 in such a way that its compression surface 72 extends opposite a surface of the groove 39, in the raised configuration.

In a third embodiment illustrated in FIGS. 10 to 15, the tie rod 42 and the compression spring 70 consist of a single one-piece part made of synthetic material obtained by so-called “two-material” injection moulding. This embodiment made of synthetic material is suitable for example for a clutch pedal assembly.

For the manufacture by moulding of such a one-piece part, the following is carried out:

the body of the tie rod 42 is manufactured by injection moulding of a first plastic material, for example a glass-fibre reinforced polyamide material. A moulding die is provided comprising a mould, for example in two portions, and a core positioned inside the mould in order to delimit at least one free moulding cavity inside of which may be injected a plastic material in molten state. This free moulding cavity is configured to shape the body of the tie rod 42 comprising the back projection 86 provided with a hollow bore.

The mould is then closed and the first plastic material is injected into the mould in the molten state. This plastic material fills the free cavity of the mould. Throughout the entire manufacturing step, particularly during the step of injecting the first plastic material into the mould, the inner volume of the hollow bore is filled by the core. Once the step of injecting the first material is finished, the core is removed. A second plastic material is then injected, for example a polyurethane elastomer material, by filling at least the bore of the tie rod to form the compression spring 70.

In this third embodiment, and as illustrated in FIG. 11, the compression spring 70 has an upper compression surface 72A and a lower compression surface 72B extending on either side of the tie rod 42 in its longitudinal direction (here on the side of the pedal 34 and on the opposite side of the driving lever 44). For example, the compression spring 70 is arranged on the tie rod 42 so as to position, in the raised configuration, the lower compression surface 72B of the spring 70 substantially in line and in contact with a surface of a top portion 45 of the driving lever 44, adjacent to the second joint 48. The spring 70 with its two opposite compression surfaces 72A and 72B, in its compressed state, exerts a thrust force simultaneously on the pedal 34 and the driving lever 45.

In the third embodiment illustrated in FIGS. 10 to 15, the spring 70 is in the form of two ends in the form of studs connected to one another by a thin rod. In this case, the manufacture of the spring 70 by injection moulding only requires a single injection point. For the example, the bore forms a channel that passes through the projection 86 in a longitudinal direction of the tie rod 42 and that opens out on the side of the pedal 34 and on the side of the driving lever 45.

Optionally, in a first variant not illustrated, the bore may include two non-communicating blind channels each opening out on one side of the tie rod 42 requiring the injection moulding to be performed in two injection points for the filling of the two blind channels. In a second variant not illustrated, the bore may comprise a blind channel only opening out on the side of the first joint 46 of the tie rod 42 to the pedal 34 to only form the spring 70 on only one upper compression surface 72A.

In a third variant not illustrated, the tie rod may be made by injection moulding of a plastic material to form a body provided with a projection on its central portion as already explained above, and the compression spring 70 may be attached on the tie rod not by overmoulding but by forced assembly inside of said bore.

The main operating aspects of the invention will now be described according to the third embodiment with reference to FIGS. 10 to 15.

Initially, the pedal assembly 30 is in its raised configuration, in a driving phase of the motor vehicle. The compression spring 70 is in a prestressed state compressed between the surface of the groove 39 of the pedal 34 and a surface of the top portion 45 of the driving lever 44, as illustrated in FIG. 13. In this configuration, the compressed spring 70 acts by exerting a force on the main 35 and secondary joints 46 and 48 tending to reduce the functional clearances of the kinematic chain of the pedal 34. These forces are schematically shown by arrows in FIG. 15. In this case, the vibrations of the pedal 34 are limited to a level such that they are no longer perceptible for the user of the vehicle.

Then, during a braking action of the vehicle, the user applies a pressure on the pad 38 of the brake pedal to depress the pedal 34 in the operational direction and thus drive the actuation of the braking device.

The pedal pivots around its main joint 35 driving in its movement equally the tie rod 42 and the driving lever 44 of the articulated connection 40 as seen in FIG. 12.

This has the effect of moving the surface of the groove 39 of the pedal 34 away from the upper compression surface 72A of the compression spring 70 and equally the surface of the top portion 45 of the driving lever 44 away from the lower compression surface 72B of the compression spring 70.

Moreover, due to these movements, a release of the stress exerted by the compression spring 70 on the pedal 34 then occurs, the spring 70 initiating a relaxation stroke until reaching its final relaxed state.

In this depression configuration, it is clearly understood that the resistive torque exerted by the compression spring 70 disappears to the benefit of the functional torque of the pedal assembly 30 that makes it possible to ensure the braking function of the pedal control as seen in FIG. 14.

The invention is not limited to the embodiments described above. Other embodiments within the reach of the person skilled in the art may also be envisaged without departing from the scope of the invention defined by the following claims. Thus it is in this way, particularly, that there would be no deviation from the scope of the invention by modifying the detail shape of the spring forming the member for adjusting a clearance.

1. A pedal assembly for pedal control of a steering function of a motor vehicle, comprising a support provided to be mounted laterally on one side of the motor vehicle, a pedal mounted pivoting around a pivot axle of the support and an articulated connection, the connection being configured to connect the pedal to a transverse return bar of the control connected to a device for controlling the steering function, provided to be mounted on the other side of the vehicle, such that the application of a functional torque for driving the pedal around the axle from a raised inactive configuration to a depressed active configuration drives the rotation of the bar by means of the articulated connection causing the actuation of the device, wherein the pedal assembly comprises a member for adjusting a functional clearance of the pedal, the member being configured to exert a resistive torque on said pivot axle of the pedal in a direction opposite to the direction of the functional torque, which tends to disappear during the depression of the pedal.

2. The pedal assembly according to claim 1, wherein the adjusting member comprises a spring configured to adopt in the raised configuration of the pedal, an operating state wherein the spring exerts a force on the pedal by urging it to pivot around its axle in a direction opposite to its direction of depression and to adopt during the depression of the pedal, a relaxed state wherein the spring tends to release the pedal from the exertion of its force.

3. The pedal assembly according to claim 2, wherein the member comprises a spring operating in compression, mounted integral with the articulated connection, and configured to exert a compressive force against the pedal in its operating state.

4. The pedal assembly according to claim 3, wherein the articulated connection supports the spring so as to position at least one upper compression surface of the spring substantially in line and in contact with a lower edge of the pedal in the raised configuration of the pedal and to move it away, for example angularly, from the lower edge during the depression of the pedal.

5. The pedal assembly according to claim 3, wherein the articulated connection comprises a tie rod connected to a substantially middle portion of the pedal in a first rotational joint and a driving lever configured to be mounted in a rotationally fixed manner on the return bar and connected to the tie rod in a second rotational joint, the compression spring being supported by the tie rod.

6. The pedal assembly according to claim 5, wherein the tie rod supports the spring so as to position, in the raised configuration, a lower compression surface of the spring substantially in line and in contact with a surface of a top portion of the driving lever, adjacent to the second joint.

7. The pedal assembly according to claim 5, wherein the lower edge of the pedal comprises a profile delimiting a groove in the middle portion of the pedal, adjacent to the first joint, the tie rod supports the compression spring so as to position a compression surface of the spring opposite a surface of the groove, in the raised configuration.

8. The pedal assembly according to claim 5, wherein the tie rod comprises a body defining a central portion and two joint end portions, the central portion being provided with a back or front projection delimiting a housing for receiving the compression spring configured to position a compression surface of the spring against a lower edge of the pedal, in the raised configuration of the pedal.

9. The pedal assembly according to claim 8, wherein the body of the tie rod comprises two tongues extending in the direction of their length in a longitudinal direction of the tie rod opposite one another and being connected in the central portion of the tie rod via the back or front projection.

10. The pedal assembly according to claim 9, wherein the tongues of the tie rod locally converge towards one another to define a tightening area shaped to hold tightly and retain a securing lug formed in the spring.

11. The pedal assembly according to claim 9, wherein the tie rod is obtained by bending in two a single metal part, the part comprising two oblong lateral portions configured to form the tongues and an intermediate portion for mutual transverse connection of the two oblong portions configured to form the projection delimiting the housing of the spring, the part being bent so as to bring the oblong portions opposite one another by curving the intermediate portion on itself to delimit a wall of the housing.

12. The pedal assembly according to claim 1, wherein the tie rod comprises a body defining a central portion and two joint end portions, the central portion being provided with a back or front projection delimiting a housing for receiving the compression spring configured to position a compression surface of the spring against a lower edge of the pedal, in the raised configuration of the pedal, and
wherein the tie rod and the compression spring consist of a single part obtained by two-material injection moulding of a first plastic material by filling a free cavity of a mould delimiting the body of the tie rod provided with a hollow bore and by injection moulding of a second plastic material by filling at least the hollow bore of the tie rod to form the compression spring.

13. The pedal assembly according to claim 12, wherein the bore forms a channel passing through the projection in a longitudinal direction of the tie rod, the channel opening out on the side of the first joint of the tie rod and on the side of the second joint of the tie rod.

14. The pedal assembly according to claim 3, wherein the compression spring is formed by a stud made of deformable elastomer material.

15. The pedal assembly according to claim 2, wherein the member comprises a torsion spring of the winding type mounted around the pivot axle, urging the pedal to pivot around its axle in a direction opposite to an operational direction of depression of the pedal.

16. The pedal assembly according to claim 15, wherein the pedal comprises a relief configured to bring the spring in a prestressed operating state, in the raised configuration of the pedal, and to release the spring from this prestressed state at the beginning of a depression stroke of the pedal.

17. The pedal assembly according to claim 16, wherein the relief is formed by a recess formed in an upper edge of the pedal that defines a bearing seat against which comes to apply an end portion of the spring.

18. The pedal assembly according to claim 15, wherein the torsion spring comprises an end portion integral with the pedal and a free end portion that is configured to come to press against the support in the raised position of the pedal so that the spring is in a prestressed state and is configured to be released from its pressing against the support in the depressed position of the pedal so that the spring is in a rest position.

19. The pedal assembly according to claim 18, wherein the pedal body comprises an orifice offset in relation to the pivot axle inside of which is inserted the end portion of the spring.
